(19) United States
(12) Patent Application Publication
(10) Pub. No.: US 2008/0203938 A1
(43) Pub. Date: Aug. 28, 2008

(54) Block Dimming for Hid Lamps

(75) Inventor: Hendrik Anton Van Esveld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,584

(22) PCT Filed: Sep. 19, 2005
(86) PCT No.: PCT/IB05/53068

§ 371 Date: Mar. 20, 2007

(30) Foreign Application Priority Data
Sep. 27, 2004 (EP) 04104689.7

(51) Int. Cl. H05B 41/36

(52) U.S. Cl. 315/284

(57) ABSTRACT

To dim a high intensity gas discharge (HID) lamp an inductance is connected in series with said HID lamp. The inductance functions as a ballast. The HID lamp is supplied by a frequency adjustable AC voltage supply. Since the impedance of the inductance is dependent on the frequency of the supply voltage, the current through the inductance is dependent on said frequency. Thus, the lamp current may be controlled by changing the frequency of the supply voltage, while the voltage is kept high kept high to prevent the lamp from extinguishing. The method and circuit of the present invention are suitable for driving a number of HID lamps simultaneously. Further, the HID lamp may be dimmed to about 20% of its nominal power, depending on the type of HID lamp. Dimming may be performed substantially instantly without extinction of the lamp.

The present invention relates to a method for dimming a high density gas discharge lamp and in particular to dimming a series (block) of such lamps.

Block dimming systems are known in the art. Such block dimming circuits are configured to drive a number of high intensity gas discharge (HID) lamps in a power range, i.e. from a rated or maximum power to a power less than a rated or maximum power. The block dimming system is suited for dimming said number of lamps simultaneously. The HID lamps are provided with their specific ballast circuits for driving said HID lamps. The known block dimming circuits lower the voltage across the HID lamp and the corresponding passive ballast circuit, thereby lowering the power supplied.

The above-mentioned known block dimming method is however only suitable for dimming HID lamps, e.g. metal halide lamps, to approximately 50% of their maximum power. At the corresponding voltage, the HID lamp extinguishes, since the voltage across the lamp is lower than a required reignition voltage. In normal operation, due to a periodic current reversal, the lamp is reignited each period by a voltage peak higher than said predetermined reignition voltage. If the voltage peak is lowered and approaches said predetermined reignition voltage, the lamp may not reignite again. Further, due to a lower lamp current, the lamp may start to flicker.

Moreover, if the lamp voltage is lowered in a short period, the lamp may extinguish even before the voltage is below said predetermined reignition voltage due to the dynamic behavior of the lamp plasma.

DE 29 31 794 discloses to control the frequency of a block shaped HID lamp current by controlling an electronic ballast circuit of the HID lamp for dimming the HID lamp. When controlling a number of HID lamps, each ballast circuit has to be controlled to output a desired frequency. Such a ballast circuit requires a complex system for controlling each ballast circuit and is therefore unsuitable for dimming a large number of HID lamps.

It is an object of the present invention to provide a circuit and a method for dimming a number of HID lamps to less than 50% of their maximum power.

The above object is achieved in a lamp dimming circuit according to claim 1, in a method for dimming a lamp according to claim 4 and in a method for block dimming a number of HID lamps according to claim 5.

The lamp dimming circuit according to the present invention may drive and dim one or more HID lamps by changing a frequency of a supply voltage output by a frequency adjustable voltage supply. The inductance connected in series with said HID lamp has a frequency dependent impedance. When the frequency of the voltage output by the voltage supply is changed, the impedance of the inductance changes, thereby changing the current through the impedance. The voltage across the lamp, however, does not substantially change. Thus, the current through the lamp is changed while the voltage is kept substantially equal, thereby changing the light output by the lamp while preventing the lamp from extinguishing.

When the frequency of the voltage is increased, the impedance of the inductance is increased. Thus, with a high frequency, the current through the lamp is lowered, thereby lowering the light output of the lamp. Due to the high frequency, flickering of the lamp would be no problem, since such at a high frequency flickering of the lamp is not visible for the human eye.

The current flowing through the inductance comprises an amount of energy. Said energy may enable to dim a HID lamp or a number of HID lamps in a short period, i.e. substantially instantaneously. The energy is then employed to prevent extinction of the lamp during dimming. The energy stored in the inductance may increase the lamp voltage to twice the nominal voltage during a short period of time, when the frequency of the supplied current is changed.

Using the lamp dimming circuit according to the present invention, it is possible to dim a HID lamp, e.g. a metal halide lamp, down to 25% of its nominal power, whereas the conventional dimming circuits are restricted to approximately 50% of the nominal power.

The dimming circuit and method according to the present invention are suitable for driving and dimming one or more HID lamps such as a metal halide lamp. Such a metal halide lamp is practically not dimmable by the conventional dimming circuits and methods. According to the present invention, the metal halide lamp may even be substantially instantaneously dimmed as described above.

In an embodiment of the present invention, the frequency adjustable voltage supply is a motor drive, which is a device known in the art for supplying a high AC voltage with an adjustable frequency and with high power. Therefore, such a motor drive is suitable for driving and dimming a block, i.e. a large number, of HID lamps, such as metal halide lamps.

These and other aspects of the present invention will be apparent from and elucidated with reference to the embodiment described hereinafter.

The annexed drawing shows a non-limiting exemplary embodiment, wherein

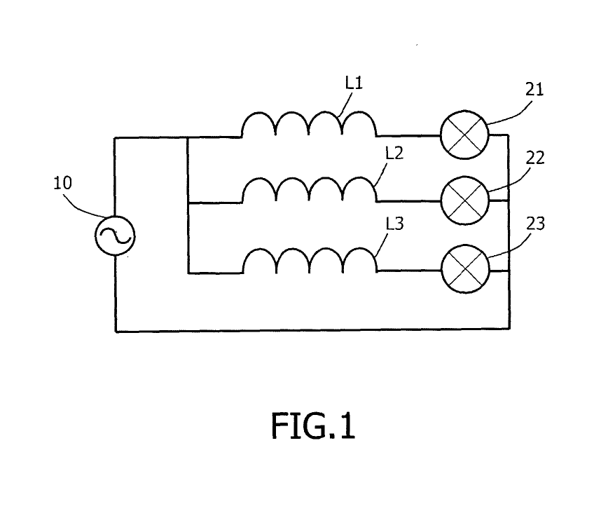

FIG. 1 schematically shows a block dimming circuit according to the present invention.

In the drawing, identical reference numerals indicate similar components or components with a similar function.

FIG. 1 shows an electrical circuit comprising an AC voltage supply 10, a number of inductance's L1, L2 and L3 and a corresponding number of HID lamps 21, 22 and 23.

The voltage supply 10 is a frequency adjustable voltage supply. The output voltage is supplied to a parallel circuit of a number, in the illustrated circuit three, of series connections of an inductance L1, L2, L3 and a HID lamp 21, 22, 23, respectively. Each lamp 21, 22, 23 may be provided with a starter circuit for igniting the HID lamp 21, 22, 23. Such a starter circuit is however not shown in FIG. 1 as the starter circuit is not relevant to the present invention.

The HID lamps 21, 22, 23 and inductances L1, L2, L3 are supplied with an alternating, e.g. sine shaped voltage supplied by the voltage supply 10 such as a known motor drive. The HID lamps 21, 22, 23 are for example HID lamps for use with a mains voltage such as 230 V AC at 50 Hz and having a predetermined rated power. The respective inductances L1, L2, L3 in series with each lamp functions as the ballast circuit for said lamp and the value of the inductance L1, L2, L3 is selected such that the lamp 21, 22, 23 functions at its rated power when such a mains is applied.

When the output voltage of the voltage supply 10 is changed, in particular when the frequency thereof is changed, the impedance of the inductance L1, L2, L3 changes. With an increase of the frequency, the impedance of the inductance L1, L2, L3 increases linearly with the frequency. Due to the increased impedance, the current through the inductance L1, L2, L3, and thereby the current through the HID lamp 21, 22, 23, is lowered. Thus, for example, when the frequency is increased from 50 Hz to 250 Hz, while keeping the voltage at 230 V, the impedance of the inductance L is increased 5 times, thereby lowering the current through the inductance L 5 times and thus reducing the power of the HID lamp to only 20% of its nominal power.

The circuit according to the present invention may advantageously be employed to boost the light output of a HID lamp over a short period of time. For example, the above mentioned HID lamp intended for use with a mains voltage of 230 V AC at 50 HZ may be driven at 300 V AC at 65 Hz. Due to the increased frequency, the impedance of the inductance is increased, thereby lowering a supplied current with a factor 50/65. The lamp power equals the voltage times the current. Since the voltage is increased from 230 V to 300 V, the HID lamp functions at about its rated power, since 300/65 is about equal to 230/50. Now, lowering the frequency to 50 Hz boosts the lamp to about 130% of its rated power. It is noted that HID lamps are suited for such a boost during a short period of time. It is also noted that such a circuit design decreases any visible flickering of the HID lamp compared to driving the HID lamp at 50 Hz, since the human eye is less sensitive to a frequency of 65 Hz.

Advantageously, the present invention may be employed to shorten a run-up period of a HID lamp. During the run-up period, which period is relatively long for a HID lamp, the HID lamp comes to a stable operation. It is known in the art to increase the lamp current during the run-up period to shorten the run-up period. By lowering the frequency of the current, the current is increased according to the present invention.

Further, the present invention may be employed to correct for an unstable mains voltage such that the lamp power is kept substantially constant. For example, if there is no voltage stabilizer in the circuit, the frequency of the lamp current may be controlled to vary with any variations in the mains voltage in order to keep the power dissipated by the lamp constant.

In the above description as well as in the appended claims, ‘comprising’ is to be understood as not excluding other elements or steps and ‘a’ or ‘an’ does not exclude a plurality. Further, any reference signs in the claims shall not be construed as limiting the scope of the invention.

1. A lamp dimming circuit for dimming at least one HID lamp (21, 22, 23), the circuit comprising an inductance (L1, L2, L3) for a series connection with each HID lamp and a frequency adjustable voltage supply (10) for supplying an alternating voltage with a predetermined frequency to said series connection of said inductance and said HID lamp.

2. The lamp dimming circuit according to claim 1, wherein the alternating voltage is a sine wave voltage.

3. The lamp dimming circuit according to claim 1, wherein the frequency adjustable voltage supply is a motor drive.

4. Use of a lamp dimming circuit according to claim 1, wherein the HID lamp is a metal halide lamp.

5. Method for dimming a HID lamp (21, 22, 23), the method comprising: setting a frequency of an alternating supply voltage output by a voltage supply (10); and supplying said supply voltage to a series connection of said HID lamp and an inductance (L1, L2, L3).

6. Method for block dimming a number of HID lamps (21, 22, 23), the method comprising: setting a frequency of an alternating supply voltage output by a voltage supply (10); and supplying said voltage to each of a number of series connections of a HID lamp and an inductance (L1, L2, L3).
